(19) United States
(12) Patent Application Publication
(10) Pub. No.: US 2010/0036781 A1
(43) Pub. Date: Feb. 11, 2010

(54) APPARATUS AND METHOD PROVIDING RETRIEVAL OF ILLEGAL MOTION PICTURE DATA

(75) Inventors: Byeong Cheol CHOI, Daejeon (KR); Seung Wan HAN, Gwangju (KR); Chi Yoon JEONG, Daejeon (KR); Jae Deok LIM, Daejeon (KR); So Hee PARK, Daejeon (KR); Jeong Nyeo KIM, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/465,900

(22) Filed: May 14, 2009

(30) Foreign Application Priority Data
Aug. 7, 2008 (KR) 10-2008-0077495

(51) Int. Cl. G06F 15/18; G06N 5/02

(52) U.S. Cl. 706/12; 706/54

(57) ABSTRACT

Provided are an apparatus and method for detecting illegal motion picture data. The apparatus includes a key frame extractor for extracting a plurality of key frames from motion picture data, a characteristic value file generator for detecting characteristic values of the extracted key frames and generating a characteristic value file, and an illegality determiner for measuring degree of similarity between a previously stored learning model file and the characteristic value file and determining whether or not the motion picture data is legal according to the degree of similarity.

### CROSS-REFERENCE TO RELATED APPLICATION

This application claims priority to and the benefit of Korean Patent Application No. 10-2008-0077495, filed on Aug. 7, 2008, the disclosure of which is incorporated herein by reference in its entirety.

### BACKGROUND

1. Field of the Invention

The present invention relates to an apparatus and method providing retrieval of illegal motion picture data, and more particularly, to an apparatus and method for determining whether or not motion picture data to be monitored for copyright is legal in order to protect the copyright of copyright motion picture data.

This work was supported by the IT R&D program of MIC/IITA. [2007-S-016-02, Development of Cost Effective and Large Scale Global Internet Service Solution].

2. Discussion of Related Art

Fueled by the growth of the Internet, illegal distribution of motion picture data by peer-to-peer (P2P) websites and file-sharing websites utilizing Internet-based storage has become widespread. Consequently, the prevention of such illegal distribution of motion picture data has become an important social issue.

The illegal distribution of motion picture data is enabled by the development of networks which enable mass duplication and real-time distribution of motion picture data, and by the development of motion picture data editing and codec techniques whereby several hundred or more pieces of variant motion picture data can be generated by the same motion picture data source.

According to a conventional method of detecting illegal motion picture data used in such an environment, it is difficult to determine whether or not variant motion picture data corresponding to motion picture data to be monitored for copyright is legal.

### SUMMARY OF THE INVENTION

The present invention is directed to providing an apparatus and method for detecting illegal motion picture data in consideration of numerous variants of copyright motion picture data.

One aspect of the present invention provides an apparatus for detecting illegal motion picture data, comprising: a key frame extractor for extracting a plurality of key frames from motion picture data; a characteristic value file generator for detecting characteristic values of the extracted key frames and generating a characteristic value file; and an illegality determiner for measuring degree of similarity between a previously stored learning model file and the characteristic value file, and determining whether or not the motion picture data is legal according to the degree of similarity.

Another aspect of the present invention provides a method of detecting illegal motion picture data, comprising: extracting a plurality of key frames from motion picture data to be monitored for copyright; detecting characteristic values of the extracted key frames and generating a characteristic value file; measuring degree of similarity between the generated characteristic value file and a previously stored learning model file; and determining whether or not the motion picture data to be monitored for copyright is legal according to the degree of similarity.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 illustrates an environment in which an apparatus for detecting illegal motion picture data according to an exemplary embodiment of the present invention is employed;

FIG. 2 is a block diagram of an apparatus for detecting illegal motion picture data according to an exemplary embodiment of the present invention;

FIG. 3 illustrates a process in which an apparatus for detecting illegal motion picture data according to an exemplary embodiment of the present invention generates a learning model file;

FIG. 4 illustrates an example of a learning model file used in an apparatus for detecting illegal motion picture data according to an exemplary embodiment of the present invention;

FIG. 5 is a flowchart showing a process of determining whether or not motion picture data to be monitored for copyright is legal on the basis of a learning model file according to an exemplary embodiment of the present invention;

FIG. 6A and FIG. 6B shows graphs illustrating how an apparatus for detecting illegal motion picture data according to an exemplary embodiment of the present invention can determine whether or not motion picture data to be monitored for copyright is illegal using degree of similarity between the motion picture data and a learning model file; and

FIG. 7 is a table showing accuracies of an apparatus for detecting illegal motion picture data according to an exemplary embodiment of the present invention determining motion picture data to be illegal.

### DETAILED DESCRIPTION OF EXEMPLARY EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention.

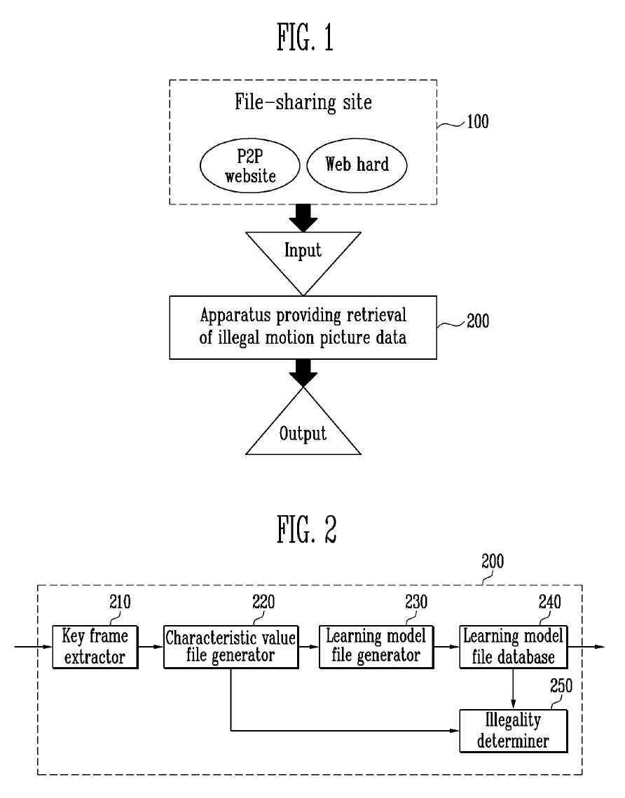

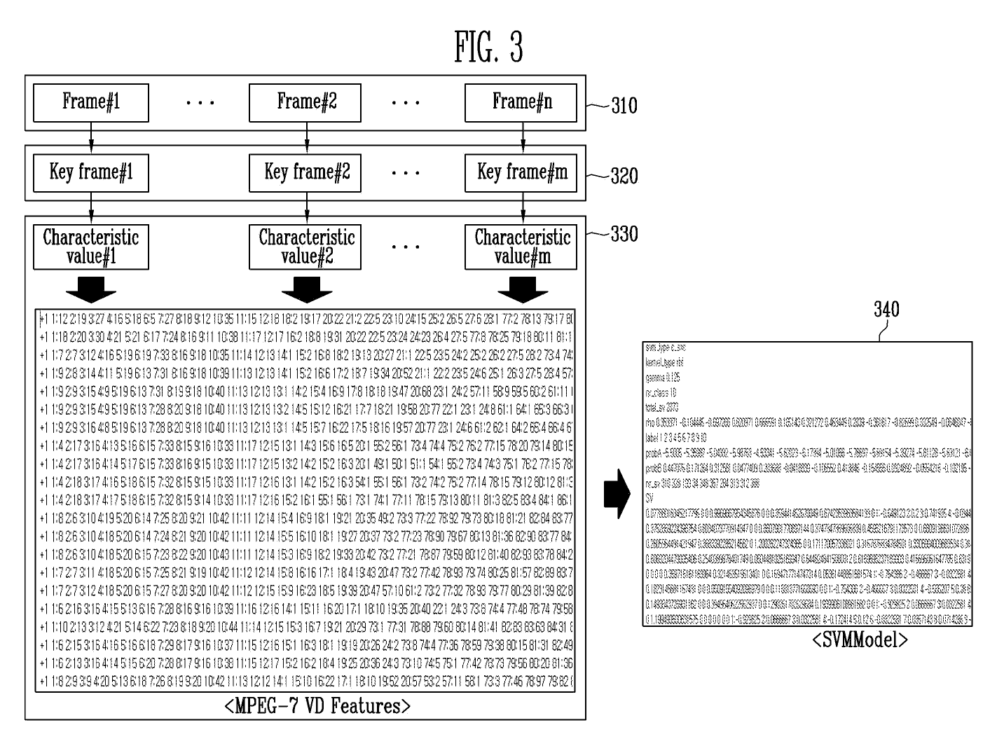

An apparatus for detecting illegal motion picture data according to an exemplary embodiment of the present invention will be described below with reference to FIGS. 1 and 2.

FIG. 1 illustrates an environment in which an apparatus for detecting illegal motion picture data according to an exemplary embodiment of the present invention is employed, and FIG. 2 is a block diagram of an apparatus for detecting illegal motion picture data according to an exemplary embodiment of the present invention.

Referring to FIG. 1, the environment in which an apparatus for detecting illegal motion picture data according to an exemplary embodiment of the present invention is employed includes a file-sharing website 100 for downloading motion picture data to be monitored for copyright (hereinafter referred to as copyright-monitored motion picture data), and an illegal motion picture data detection apparatus 200 for determining whether or not the downloaded copyright-monitored motion picture data is legal.

The file-sharing website 100 includes a peer-to-peer (P2P) website and a file-sharing website utilizing Internet-based storage. The illegal motion picture data detection apparatus 200 determines whether or not copyright-monitored motion picture data downloaded from the file-sharing website 100 is legal and outputs the determination result.

The illegal motion picture data detection apparatus 200 will be described in detail with reference to FIG. 2.

The illegal motion picture data detection apparatus 200 includes a key frame extractor 210, a characteristic value file generator 220, a learning model file generator 230, a learning model file database 240 and an illegality determiner 250.

When copyright motion picture data or copyright-monitored motion picture data is input, the key frame extractor 210 decodes the input motion picture data and extracts a plurality of key frames using header information obtained by decoding the motion picture data.

The characteristic value file generator 220 detects characteristic values of the respective key frames to allow the key frames extracted by the key frame extractor 210 to be searched for on the basis of a reference such as a color, feeling of material, form and voice, and generates a characteristic value file of the copyright motion picture data or copyright-monitored motion picture data including the detected characteristic values of the key frames. In an exemplary embodiment, the characteristic value file generator 220 may detect a characteristic value of a key frame using motion picture experts group (MPEG)-7 visual descriptors including a Color Layout Descriptor (CLD), a Color Structure Descriptor (CSD), an Edge Histogram Descriptor (EHD), a Region Shape Descriptor (RSD), and so on.

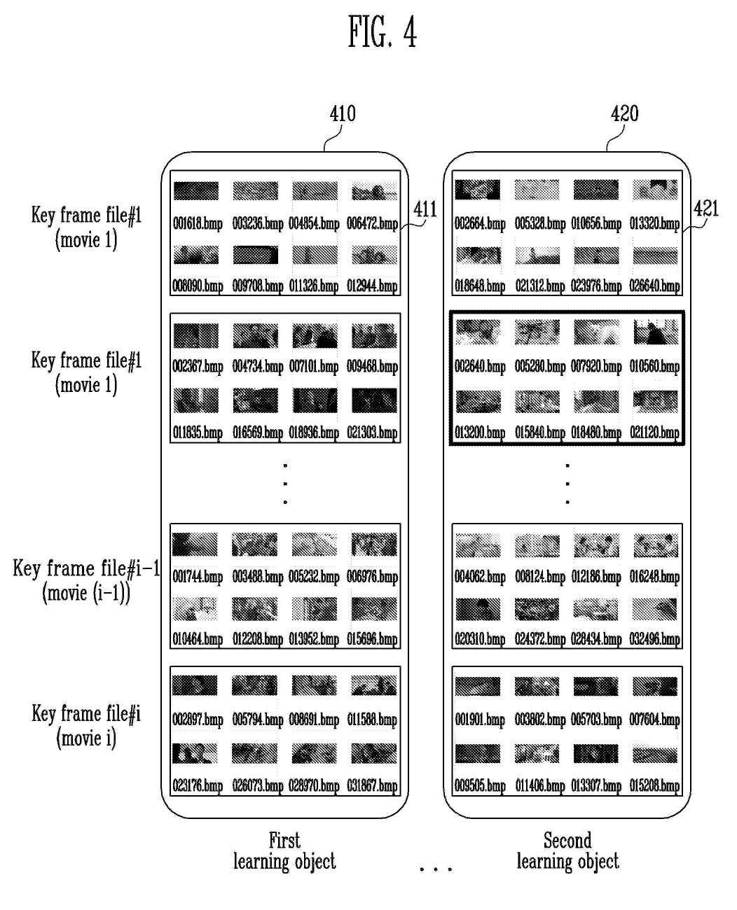

Using characteristic value files of copyright motion picture data generated by the characteristic value file generator 220, the learning model file generator 230 generates a learning model file to be used for determining whether or not the copyright-monitored motion picture data is legal. In an exemplary embodiment, the learning model file may be generated on the basis of a learning module of a support vector machine (SVM). A process of generating a learning model file and an example of the learning model file will be described later in detail with reference to FIGS. 3 and 4.

The learning model file database 240 stores the learning model file generated by the learning model file generator 230 and a range file, which is required for a characteristic value scaling process.

The illegality determiner 250 measures degree of similarity between the characteristic value file of the copyright-monitored motion picture data generated by the characteristic value file generator 220 and a learning model file stored in the learning model file database 240 and determines whether the copyright-monitored motion picture data is legal. In an exemplary embodiment, the illegality determiner 250 may determine whether or not the copyright-monitored motion picture data is legal on the basis of a determination module of an SVM.

A process in which the illegality determiner 250 determines whether or not the copyright-monitored motion picture data is legal will be described. The illegality determiner 250 determines a characteristic value file having the highest degree of similarity to the characteristic value file of the copyright-monitored motion picture data from among characteristic value files of copyright motion picture data included in the learning model file.

Subsequently, the illegality determiner 250 determines whether or not key frames included in the characteristic value file of copyright motion picture data having the highest degree of similarity are the same as the key frames included in the characteristic value file of the copyright-monitored motion picture data by as much as a specific threshold value or more.

When the illegality determiner 250 determines that the characteristic value file of the copyright motion picture data is the same as the characteristic value file of the copyright-monitored motion picture data by as much as the specific threshold value or more, it determines the copyright-monitored motion picture data to be illegal motion picture data. In an exemplary embodiment, the illegality determiner 250 may determine the degree of similarity between the copyright motion picture data and the copyright-monitored motion picture data using an M-of-N determination value. Here, a probability of the illegality determiner 250 correctly detecting illegal motion picture data using an M-of-N determination value is defined as shown below (a formula for calculating a degree of M-of-N determination value similarity).

$${P}_{x} = {\sum }_{m = k}^{n} ( \begin{matrix}n \\ m\end{matrix} ) {{p}_{f}^{m} ( 1 - {p}_{f} )}^{n - m} \qquad ( here , n > m )$$

Here, n denotes the number of key frames compared with key frames of copyright motion picture data among key frames extracted from copyright-monitored motion picture data, and m denotes the number of key frames the same as key frames of the copyright motion picture data among the n compared key frames. P_{f} denotes a probability that one key frame of the copyright-monitored motion picture data is the same as a key frame of the copyright motion picture data. In an exemplary embodiment, a threshold value of P_{f} may be 0.935, and a probability Pₓ of correctly determining that motion picture data is illegal may have a threshold value of 0.9.

A learning model file used for measuring degree of similarity between copyright motion picture data and copyright-monitored motion picture data will be described below with reference to FIGS. 3 and 4.

FIG. 3 illustrates a process in which an apparatus for detecting illegal motion picture data according to an exemplary embodiment of the present invention generates a learning model file, and FIG. 4 illustrates an example of a learning model file used in an apparatus for detecting illegal motion picture data according to an exemplary embodiment of the present invention.

Referring to FIGS. 3 and 4, to generate a characteristic value file of copyright motion picture data, the apparatus for detecting illegal motion picture data determines a plurality of frames of input copyright motion picture data (310) and extracts a plurality of key frames from the determined frames (320).

Then, the apparatus for detecting illegal motion picture data detects characteristic values from the extracted key frames and generates a characteristic value file including the detected characteristic values of the key frames (330). Here, the apparatus for detecting illegal motion picture data may detect the characteristic values of the key frames using the MPEG-7 visual descriptors and generate characteristic value files, e.g., 411 and 421 shown in FIG. 4 using the detected characteristic values of the key frames.

Subsequently, the apparatus for detecting illegal motion picture data determines whether or not there are at least two characteristic value files of the copyright motion picture data and generates a learning model file of the copyright motion picture data when there are at least two characteristic value files of the copyright motion picture data (340). In an exemplary embodiment, the learning model file may be generated on the basis a learning module of an SVM, and may be generated to be classified as one or more learning objects, e.g., 410 and 420 shown in FIG. 4, on the basis of characteristic values of one or more characteristic value files, e.g., 411 and 421 shown in FIG. 4, such that memory space can be efficiently used. FIG. 4 shows a learning model file in which j learning objects each including i characteristic value files of copyright motion picture data exist.

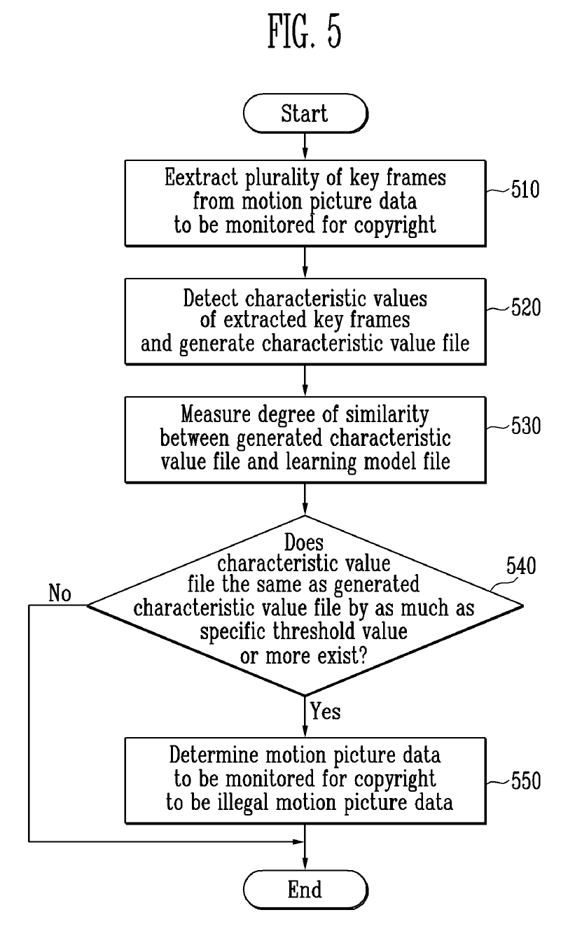

A process of determining whether or not copyright-monitored motion picture data is legal using a learning model file generated as described above will be described with reference to FIG. 5. Here, it is assumed that the illegality determiner 250 measures degree of similarity between copyright-monitored motion picture data and a learning model file using an M-of-N determination value.

FIG. 5 is a flowchart showing a process of determining whether or not copyright-monitored motion picture data is legal on the basis of a learning model file according to an exemplary embodiment of the present invention.

Referring to FIG. 5, when copyright-monitored motion picture data is input, an apparatus for detecting illegal motion picture data extracts a plurality of key frames from the input copyright-monitored motion picture data (510) and generates one characteristic value file including characteristic values of the extracted key frames (520).

Here, the apparatus for detecting illegal motion picture data decodes the downloaded copyright-monitored motion picture data, extracts the key frames using header information among image information obtained by decoding the copyright-monitored motion picture data, detects the characteristic values of the key frames on the basis of a reference such as color, feeling of material, form and voice, and generates the characteristic value file.

Subsequently, the apparatus for detecting illegal motion picture data measures a degree of M-of-N determination value similarity between the generated characteristic value file and a previously stored learning model file (530). When it is determined (540) that a characteristic value file is the same as the generated characteristic value file by as much as a specific threshold value or more exists in the learning model file, the apparatus for detecting illegal motion picture data determines the copyright-monitored motion picture data to be illegal motion picture data (550).

Here, the apparatus for detecting illegal motion picture data measures respective M-of-N determination value similarities between the learning model file including characteristic value files of copyright motion picture data and characteristic value files of the copyright-monitored motion picture data. When the apparatus for detecting illegal motion picture data determines that there is a characteristic value file that is the same as a characteristic value file of the copyright-monitored motion picture data by as much as the specific threshold value or more among characteristic value files included in the learning model file, the apparatus for detecting illegal motion picture data determines the copyright-monitored motion picture data to be illegal motion picture data. In an exemplary embodiment, the apparatus for detecting illegal motion picture data may determine whether or not copyright-monitored motion picture data is legal on the basis of a determination module of an SVM or using M-of-N determination value similarities (when a result value obtained by determining at least M key frames among N key frames as the same characteristic value files is a threshold value of 90% or more).

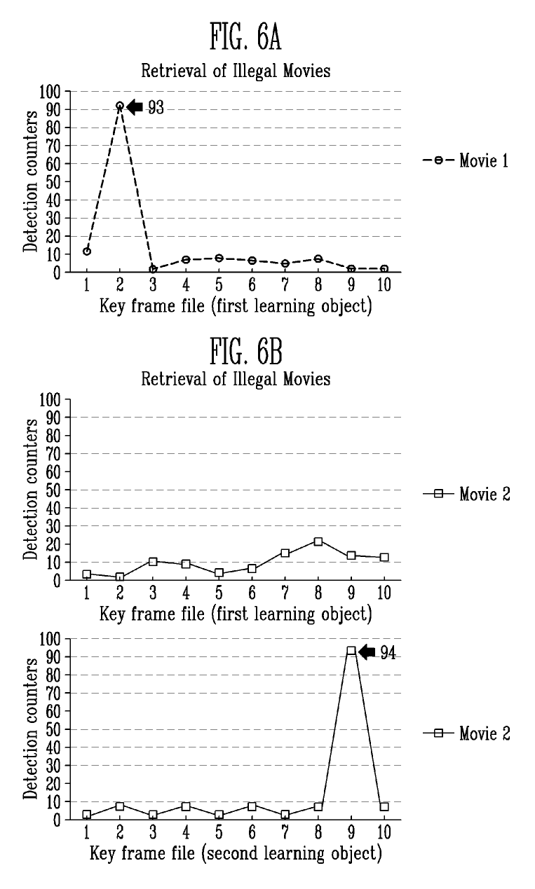

FIG. 6A and FIG. 6B shows graphs illustrating how an apparatus for detecting illegal motion picture data according to an exemplary embodiment of the present invention can determine whether or not copyright-monitored motion picture data is illegal using a degree of M-of-N determination value similarity between the copyright-monitored motion picture data and a learning model file. For convenience, it is assumed that two learning objects including characteristic value files of ten pieces of copyright motion picture data exist in the learning model file.

Referring to FIG. 6A, when a user designates copyright-monitored motion picture data Movie1 whose legality will be determined according to an exemplary embodiment of the present invention, a specific learning object whose degree of M-of-N determination value similarity to the copyright-monitored motion picture data Movie1 will be measured can be designated by the user. When it is determined whether or not the downloaded copyright-monitored motion picture data Movie1 is legal, the apparatus for detecting illegal motion picture data generates a characteristic value file of the copyright-monitored motion picture data Movie1, and measures a degree of M-of-N determination value similarity between the generated characteristic value file and a learning model file. Here, the apparatus for detecting illegal motion picture data determines whether or not the characteristic value file of the copyright-monitored motion picture data Movie1 is the same as a characteristic value file of copyright motion picture data corresponding to the learning model file by as much as a threshold value or more, thereby determining whether or not the copyright-monitored motion picture data Movie1 is legal.

In result, as illustrated in FIG. 6A, it is determined that a second characteristic value file among characteristic value files included in a first learning object is the same as the copyright-monitored motion picture data Movie1 by as much as the specific threshold value or more. Thus, the apparatus for detecting illegal motion picture data determines the copyright-monitored motion picture data Movie1 to be illegal motion picture data of copyright motion picture data corresponding to the second characteristic value file.

Meanwhile, according to another exemplary embodiment, the apparatus for detecting illegal motion picture data can determine whether or not a piece of copyright-monitored motion picture data Movie2 among many pieces of copyright-monitored motion picture data included in a specific file-sharing website is legal. In this case, a learning object included in a learning model file may not be designated by a user.

Referring to FIG. 6B, when it is determined whether or not the copyright-monitored motion picture data Movie2 is legal, the apparatus for detecting illegal motion picture data measures a degree of M-of-N determination value similarity between a characteristic value file corresponding to the copyright-monitored motion picture data Movie2 and first and second learning objects included in the learning model file, thereby determining whether or not the copyright-monitored motion picture data Movie2 is legal.

As illustrated in FIG. 6B, the apparatus for detecting illegal motion picture data measures a degree of M-of-N determination value similarity between the first and second learning objects and key frames of the copyright-monitored motion picture data Movie2. Since a ninth characteristic value file of the second learning object is the same as the copyright-monitored motion picture data Movie2 by as much as the specific threshold value or more, it is determined that the copyright-monitored motion picture data Movie2 is illegal motion picture data of copyright motion picture data corresponding to the ninth characteristic value file of the second learning object.

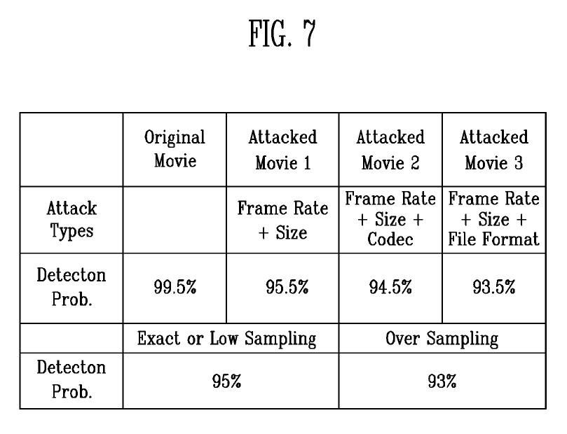

FIG. 7 is a table of accuracies of an apparatus for detecting illegal motion picture data according to an exemplary embodiment of the present invention determining copyright-monitored motion picture data to be illegal.

FIG. 7 shows experimentally measured accuracies for detecting illegal motion picture data obtained by changing a file format, frame rate, size, codec, etc., of copyright motion picture data.

Referring to FIG. 7, the apparatus for detecting illegal motion picture data according to an exemplary embodiment of the present invention determined copyright-monitored motion picture data obtained by changing the file format of the copyright motion picture data to be illegal motion picture data with an accuracy of 99.5%.

In addition, the apparatus for detecting illegal motion picture data determined copyright-monitored motion picture data obtained by changing the frame rate and size of the copyright motion picture data to be illegal motion picture data with an accuracy of 95.5%, and copyright-monitored motion picture data obtained by changing the frame rate, size and codec of the copyright motion picture data to be illegal motion picture data with an accuracy of 94.5%.

Also, the apparatus for detecting illegal motion picture data determined copyright-monitored motion picture data obtained by changing the frame rate, size and file format of the copyright motion picture data to be illegal motion picture data with an accuracy of 93.5%.

As described above, the apparatus for detecting illegal motion picture data can correctly determine whether or not copyright-monitored motion picture data is legal even if the copyright-monitored motion picture data is generated by varying copyright motion picture data in various ways.

According to an exemplary embodiment of the present invention, it is determined whether or not copyright-monitored motion picture data is legal using various pieces of key frame information on copyright motion picture data. Thus, it is possible to monitor numerous variants of the copyright motion picture data illegally circulated via P2P and file-sharing websites.

In addition, it is possible to determine whether or not copyright-monitored motion picture data is to be protected for copyright using various pieces of key frame information on copyright motion picture data. Thus, illegal distribution of digital contents can be detected and prevented.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An apparatus for detecting illegal motion picture data, comprising:
a key frame extractor for extracting a plurality of key frames from motion picture data;
a characteristic value file generator for detecting characteristic values of the extracted key frames and generating a characteristic value file; and
an illegality determiner for measuring degree of similarity between a previously stored learning model file and the characteristic value file, and determining whether or not the motion picture data is legal according to the degree of similarity.

2. The apparatus of claim 1, further comprising:
a learning model file generator for generating the learning model file using characteristic value files of one or more pieces of copyright motion picture data generated by the characteristic value file generator.

3. The apparatus of claim 2, wherein the learning model file generator generates the learning model file on the basis of a learning module of a support vector machine (SVM).

4. The apparatus of claim 1, wherein the characteristic value file generator detects the characteristic values of the extracted key frames using motion picture experts group (MPEG)-7 visual descriptors.

5. The apparatus of claim 1, wherein the illegality determiner measures the degree of similarity between the characteristic value file of the motion picture data and the previously stored learning model file on the basis of a determination module of a support vector machine (SVM).

6. The apparatus of claim 1, further comprising:
a learning model file database for storing the learning model file.

7. A method of detecting illegal motion picture data, comprising:
extracting a plurality of key frames from motion picture data to be monitored for copyright;
detecting characteristic values of the extracted key frames and generating a characteristic value file;
measuring degree of similarity between the generated characteristic value file and a previously stored learning model file; and
determining whether or not the motion picture data to be monitored for copyright is legal according to the degree of similarity.

8. The method of claim 7, further comprising, before extracting the key frames:
extracting a plurality of key frames from copyright motion picture data;
detecting characteristic values of the key frames extracted from the copyright motion picture data and generating characteristic value files of the copyright motion picture data; and
generating the learning model file using the generated characteristic value files of the copyright motion picture data.

9. The method of claim 7, wherein the measuring of the degree of similarity comprises determining whether or not the generated characteristic value file is the same as a characteristic value file of corresponding copyright motion picture data included in the learning model file by as much as a specific threshold value or more.

10. The method of claim 7, wherein the characteristic values of the extracted key frames are extracted using motion picture experts group (MPEG)-7 visual descriptors.

11. The method of claim 7, wherein the learning model file is generated on the basis of a learning module of a support vector machine (SVM).

12. The method of claim 7, wherein the degree of similarity between the characteristic value file of the motion picture data to be monitored for copyright and the learning model file is measured on the basis of a determination module of a support vector machine (SVM).
